(19) United States
(12) Patent Application Publication
(10) Pub. No.: US 2005/0030593 A1
(43) Pub. Date: Feb. 10, 2005

(54) Image capture device with stand

(76) Inventor: Gerardo Orozco-Abundis, Greeley, CO (US)

Correspondence Address: HEWLETT-PACKARD COMPANY;Intellectual Property Administration, P.O. Box 272400, Fort Collins, CO, 80527-2400, US

(21) Appl. No.: 10/637,318

(22) Filed: Aug. 8, 2003

(51) Int. Cl. H04N 1/04

(52) U.S. Cl. 358/474

(57) ABSTRACT

In accordance with an embodiment of the present invention, an improved image capture device comprises a housing having a bottom and a plurality of sides and at least one rotatable stand coupled to one of the plurality of sides and operable to rotate in a plane parallel to the side to which the at least one stand is coupled.

### TECHNICAL FIELD OF THE INVENTION

The present invention relates generally to the field of image capture devices, and more particularly to an image capture device with a stand.

### BACKGROUND OF THE INVENTION

Image capture devices, including, but not limited to, optical flatbed scanners, printers, facsimile machines, photocopiers, and/or the like, are typically used to obtain a digital image of a media object. Flatbed scanners generally include a platen against which the media object to be scanned is placed and the document lid is used to cover the platen and the media object. The document lid generally includes a document reflector which presses the media object to be imaged against the platen to provide a better image.

Generally, the scanner is placed in close proximity to other electronic equipment on a work surface. For example, the scanner may be placed next to a computer with a keyboard to enable manipulation of the scanned image. Furthermore, a printer may also occupy space next to the computer. Other electronic equipment, such as a telephone, speakers, mouse, etc. may also be present in close proximity to the scanner. Thus, a user's work surface is often very crowded. As a result, the user may choose to place the image capture device on its side. When the image capture device is placed on its side on the work surface, the device may tip over.

### SUMMARY OF THE INVENTION

In accordance with an embodiment of the present invention, an improved image capture device comprises a housing having a bottom and a plurality of sides and at least one rotatable stand coupled to one of the plurality of sides and operable to rotate in a plane parallel to the side to which the at least one stand is coupled.

In accordance with another embodiment of the present invention, a stand for an image capture device, having a bottom and sides, comprises a first arm and a second arm, wherein the first and second arms are rotatably coupled to a single side of the image capture device and are operable to rotate in a plane parallel to the side to which the arms are coupled.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a perspective view of an image capture device in accordance with an embodiment of the present invention;

FIG. 2 is a front elevational view showing a side of the image capture device of FIG. 1;

FIG. 3 is a perspective view showing the image capture device of FIG. 1 with the image capture device in a vertical position and a stand in a stored position; and

FIG. 4 is a perspective view of the image capture device of FIG. 3 with the stand in an operational position supporting the image capture device.

### DETAILED DESCRIPTION OF THE DRAWINGS

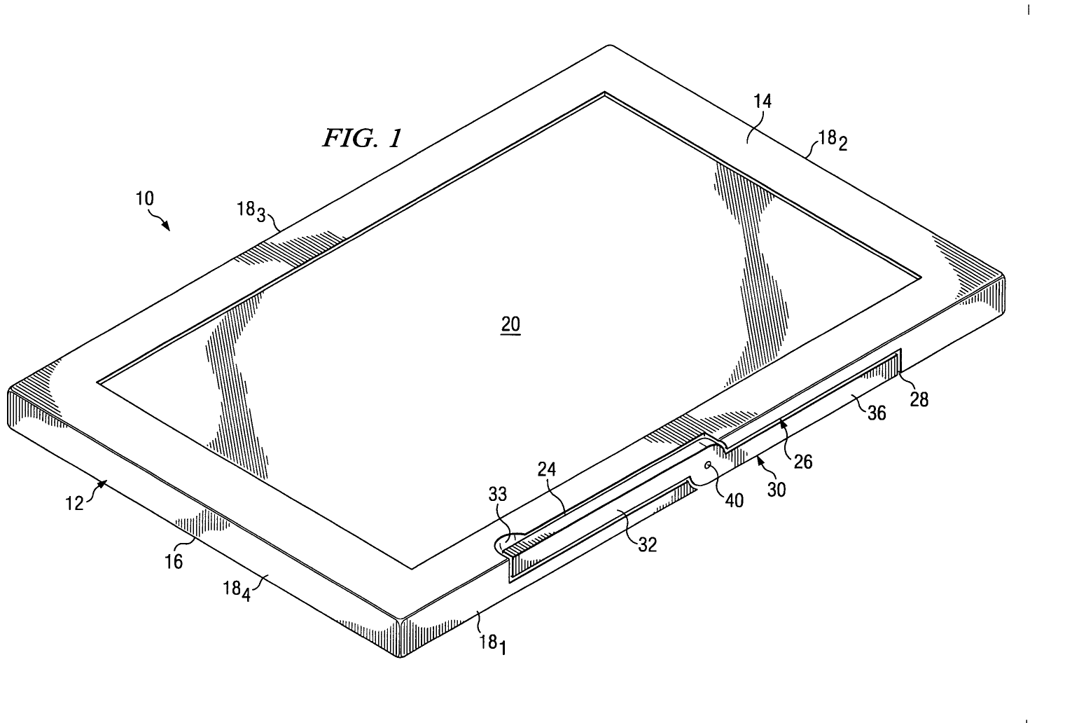

The preferred embodiment of the present invention and its advantages are best understood by referring to FIGS. 1 through 4 of the drawings.

The present invention will be described herein with reference to an image capture device, such as a scanner. The teachings of the present invention may be used with respect to other types of image capture devices, such as photocopiers, multi-function devices, facsimile machines, printers, or other machines that make a digital image for storage, transmission and further processing. Furthermore, the teachings of the present invention may be used with respect to image capture devices which are operated when placed on a work surface with the bottom surface of such devices being parallel to or along the work surface, or with respect to image capture devices which are operated when placed on the work surface with a side of such devices being parallel to or along the work surface.

FIG. 1 is a perspective view of an image capture device 10 in accordance with an embodiment of the present invention. As shown, image capture device 10 comprises a housing 12. Housing 12 comprises a top surface 14 and a bottom surface 16 opposite top surface 14. Housing 12 also comprises a plurality of vertical sides 18₁, 18₂, 18₃ and 18₄ disposed between top surface 14 and bottom surface 16. Top surface 14 comprises a platen 20 against which an object to be scanned may be placed. Although, not illustrated, if desired, device 10 may comprise a lid to cover platen 20 and the object placed thereagainst.

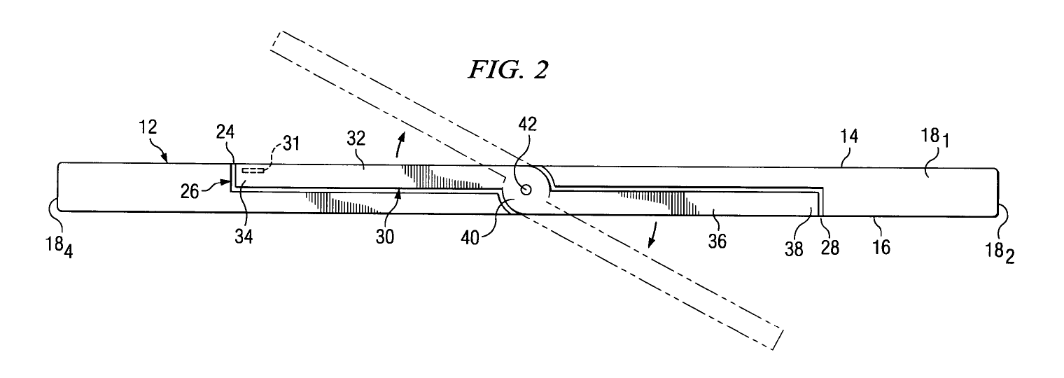

FIG. 2 is a front elevational view showing side 18₁ of image capture device 10. In accordance with an embodiment of the present invention, image capture device 10 comprises a stand 30. Stand 30 includes a first arm 32 having a free end 34 and a second arm 36 having a free end 38. First arm 32 and second arm 36 are coupled together by a pivot 40. In the illustrated embodiment, first arm 32 and second arm 36 are substantially parallel to each other. Stand 30 is disposed inside a recess 26 in housing 12 and is pivotally coupled to housing 12 of image capture device 10 at pivot 40. Although, in the illustrated embodiment, pivot 40 is located centrally in recess 26, the invention is not so limited. If desired, pivot 40 may be located anywhere along recess 26.

Stand 30 may be a single piece. If desired, stand 30 may comprise of multiple pieces. Arms 32 and 36 may be independent from each other. Furthermore, arms 32 and 36 may operate independently of each other or they may move in tandem. If desired, arms 32 and 36 may be coupled to the same pivot or different pivots. Although, in the illustrated embodiment, stand 30 is disposed inside recess 26, the invention is not so limited. In an alternative embodiment, stand 30 may be disposed on a side, say side 18₁, of housing 12 outside recess 26. Furthermore, if desired, device 10 may comprise more than one stand.

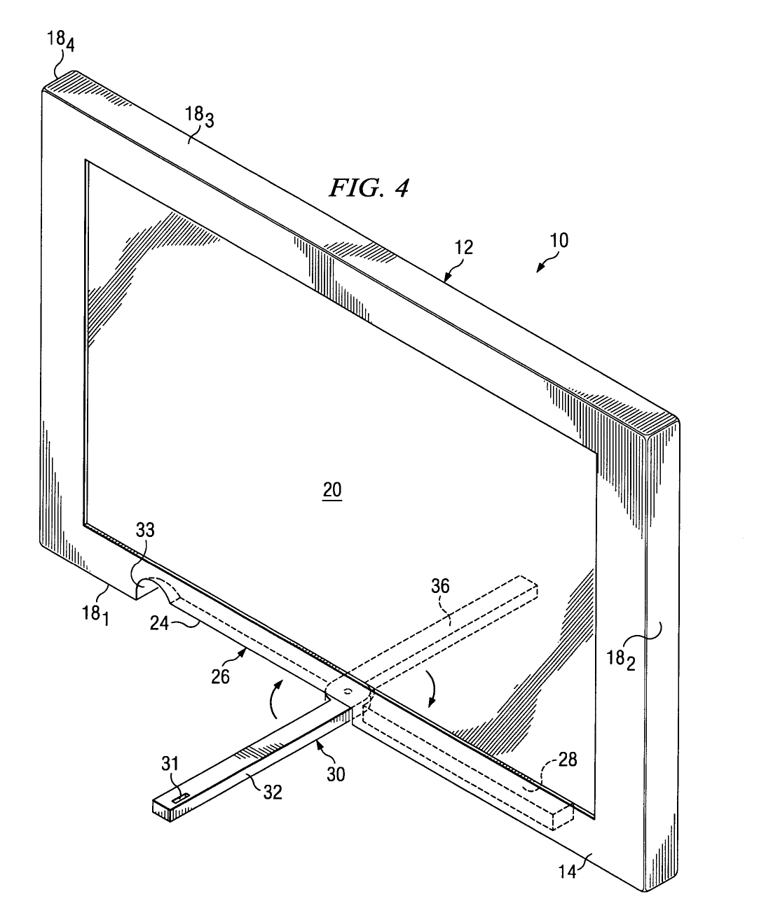

Stand 30 is operable to pivotally move between a stored position and an operational position. In the stored position, when stand 30 is not in use, stand 30 may be stored completely inside recess 26 to not increase the overall dimension of image capture device 10. In an operational position, stand 30 supports image capture device 10 in a vertical position as shown in FIG. 4, which is a perspective view of image capture device 10. In the vertical position, device 10 rests on the work surface with a side, for example side 18₁, of device 10 being along, parallel to or substantially parallel to the work surface. In an operational position of stand 30, the angle between stand 30 and bottom surface 16 of housing 12, may be any angle between zero and ninety degrees that prevents device 10 from tipping over.

Top surface 14 (FIG. 1) comprises an opening 24 which leads into recess 26 in housing 12. Top surface 14 also comprises at least one notch 33. In the illustrated embodiment, notch 33 is provided in proximity to free end 34 of first arm 32. If desired, notch 33 may be provided in proximity to free end 38 of second arm 36. Furthermore, if desired, notch 33 may be provided in proximity to the free ends of both first and second arms 32 and 36. Bottom surface 16 also comprises an opening 28 which leads into recess 26. The location of openings 24 and 28 along vertical side 18₁ facilitates positioning of image capture device 10 on its side, with vertical side 18₁ resting on the work surface. If desired, openings 24 and 28 may be provided along vertical side 18₂ to facilitate positioning of image capture device 10 on its end with vertical side 18₂ resting on the work surface. In the illustrated embodiment, vertical side 18₁ also comprises an opening into recess 26. If desired, recess 26 may be closed on the vertical side.

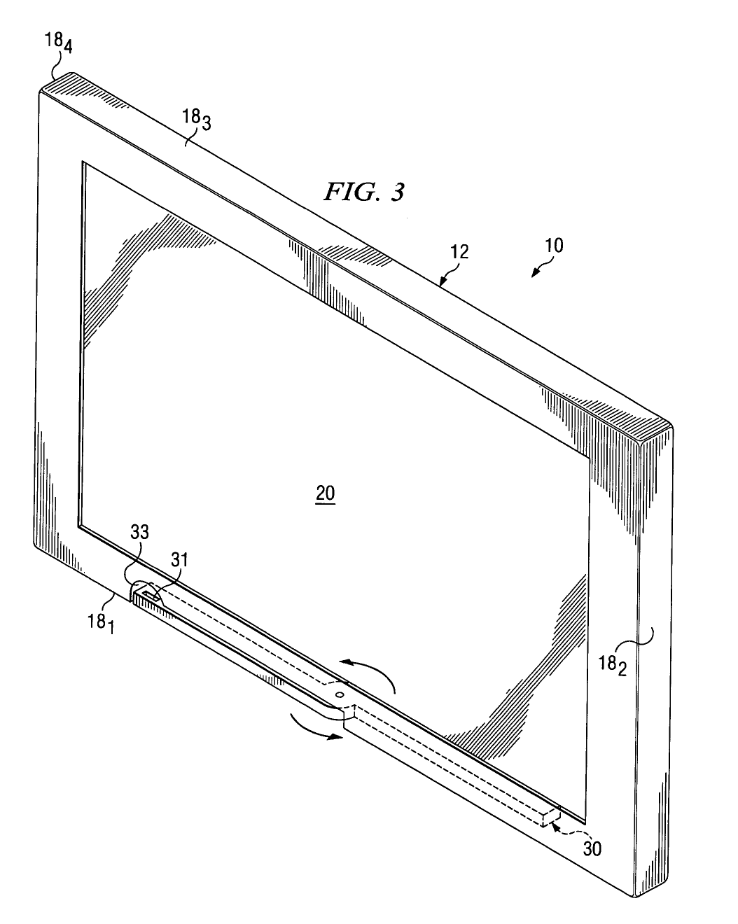

Stand 30 is pivotable about pivot 40 in a plane parallel or generally parallel to a vertical side of image capture device 10, such as vertical side 181. By rotating stand 30 around pivot 40, stand 30 may be moved from the stored position as illustrated in FIG. 3 to the operational position as illustrated in FIG. 4 and vice versa. Stand 30 may be provided with a handle 31 at or near free end 34 of first arm 32. If desired, stand 30 may be provided with handle 31 at or near free end 38 of second arm 36. Furthermore, if desired, handle 31 may be provided at or near the free ends of both first and second arms 32 and 36. Handle 31 may be employed by the user to pull first arm 32 of stand 30 from inside recess 26, to pivot stand 30 from the stored position to the operational position. In the illustrated embodiment, handle 31 comprises a groove. Notch 33 in top surface 14 enables the user to insert at least a fingertip into the groove to pivot stand 30 from the stored position to the operational position. Although in the illustrated embodiment, handle 31 comprises a groove, the invention is not so limited, and any type of handle now known or later developed may be used. Furthermore, if desired, stand 30 may not comprise a handle. In such an embodiment, the user may pivot stand 30 from the stored position to the operational position by pushing on first and second arms 32 and 36 in opposite directions. Handle 31 may be used to facilitate pivotal movement of stand 30 from the stored position to the operational position in which stand 30 supports image capture device 10 so that bottom surface 16 of image capture device 10 is vertical with respect to the work surface on which image capture device 10 is resting.

The length of stand 30 is preferably less than half the width of image capture device 10 and more than the thickness of image capture device 10 so that stand 30 does not occupy as much space as image capture device 10 would when device 10 is in the horizontal position and still provides support to image capture device 10 when device 10 is in the vertical position. In the horizontal position, device 10 rests on the work surface with bottom surface 16 of device 10 being along, parallel to or substantially parallel to the work surface. Although in the illustrated embodiment, the length of first and second arms 32 and 36 are the same, if desired, the arms may be of different length. Furthermore, the arms may be of the same or different thickness.

During use, image capture device 10 generally lies in a horizontal position with stand 30 stored within recess 26 of housing 12 as illustrated in FIG. 1. After a user finishes using image capture device 10, the image capture device may be positioned in a vertical position as shown in FIG. 3, thereby saving space that would otherwise be occupied by image capture device 10. However, because image capture device 10 is thin, it may not be able to balance on its side alone and may tip over. As such, the user may pivot stand 30 from the stored position to the operational position as shown in FIG. 4 by pulling stand 30 out of housing 12 using handle 31 such that arms 32 and 36 are on opposite sides of housing 12 and extend beyond edges of the side of device 10 to which stand 30 is coupled. Because the length of stand 30 is greater than the thickness of image capture device 10, stand 30 helps to prevent image capture device 10 from tipping over. In the illustrated embodiment, first and second arms 32 and 36 are each orthogonal to bottom surface 16 of housing 12. If desired, in an alternative embodiment, either or both of the arms could be at an angle other than ninety degrees with respect to bottom surface 16 of housing 12. When the user desires to use the image capture device, stand 30 may be pivoted back and stored in or along housing 12 and the image capture device lowered to the horizontal position. Although embodiments of the present invention have been described herein with reference to an image capture device that is operated in the horizontal position, the invention is not so limited. In an alternative embodiment, the teachings of the present invention may be used to prevent an image capture device which is operated in the vertical position, from tipping over whether or not such device is being used.

A technical advantage of an exemplary embodiment of the present invention is that the stand is part of the image capture device. Another technical advantage of an exemplary embodiment of the present invention is that the footprint of the image capture device takes up a significantly less space. Another technical advantage of an exemplary embodiment of the present invention is that the stand may be stored completely inside the housing of the image capture device.

1. An improved image capture device, comprising:
a housing having a bottom and a plurality of sides; and
at least one rotatable stand coupled to one of said plurality of sides and operable to rotate in a plane parallel to said side to which said at least one stand is coupled.

2. The improved image capture device of claim 1, wherein said at least one rotatable stand is operable to support said image capture device so that said bottom of said housing is vertical with respect to a surface on which said image capture device is resting.

3. The improved image capture device of claim 1, wherein said housing defines at least one recess operable to store said at least one stand.

4. The improved image capture device of claim 1, wherein said at least one stand is pivotable from a stored position within a recess to an operational position.

5. The improved image capture device of claim 4, wherein said operational position of said at least one stand is generally orthogonal to said side to which said stand is coupled

6. The improved image capture device of claim 1, further comprising at least one handle disposed on said stand.

7. The improved image capture device of claim 1, wherein said at least one stand is coupled to said side of said housing by a pivot.

8. The improved image capture device of claim 1, wherein said at least one stand comprises a first arm and a second arm.

9. The improved image capture device of claim 8, wherein when said at least one stand is in an operational position, said first arm and said second arm extend from said housing in opposite directions with respect to each other to support said image capture device when it is positioned on its side.

10. The improved image capture device of claim 8, wherein when supporting said image capture device in said vertical position said first arm and said second arm are orthogonal to said bottom of said housing.

11. The improved image capture device of claim 1, wherein when supporting said image capture device, a first arm and a second arm of said at least one stand are at an angle other than ninety degrees with respect to the bottom of said housing.

12. The improved image capture device of claim 1, wherein said image capture device is selected from the group consisting of a scanner, a photocopier, a facsimile machine and a printer.

13. A stand for an image capture device, said image capture device having a bottom and sides, comprising a first arm and a second arm, wherein said first and second arms are rotatably coupled to a single side of said image capture device and are operable to rotate in a plane parallel to the side to which the arms are coupled.

14. The stand of claim 13, further comprising a handle disposed in proximity to a free end of at least one of said arms.

15. The stand of claim 14, wherein in an operational position, said arms of said stand are orthogonal to the bottom of said image capture device.

16. The stand of claim 15, wherein in said operational position, said first arm and said second arm extend beyond opposite edges of said side of said image capture device to which the arms are coupled.

17. The stand of claim 13, wherein said image capture device is selected from the group consisting of a scanner, a photocopier, a facsimile machine and a printer.

18. The stand of claim 13, wherein said first and second arms move in tandem.

19. The stand of claim 13, wherein said first and second arms are coupled to each other.

20. The stand of claim 13, wherein said stand is operable to support said image capture device so that said bottom of said image capture device is vertical with respect to a surface on which said image capture device is resting.

21. The stand of claim 13, wherein when supporting said image capture device, said first arm and said second arm are at an angle other than ninety degrees with respect to the bottom.
